(19) United States
(12) Patent Application Publication
(10) Pub. No.: US 2008/0067270 A1
(43) Pub. Date: Mar. 20, 2008

(54) Food Waste Disposer with Wireless Touch Pad Control Information System

(75) Inventor: William F. Strutz, Racine, WI (US)

Correspondence Address: HARNESS, DICKEY & PIERCE, P.L.C., P.O. BOX 828, BLOOMFIELD HILLS, MI, 48303, US

(73) Assignee: Emerson Electric Co., St. Louis, MO (US)

(21) Appl. No.: 11/926,392

(22) Filed: Oct. 29, 2007

Related U.S. Application Data
(63) Continuation of application No. 11/306,143, filed on Dec. 16, 2005.
Application No. 11/306,143 is a continuation-in-part of application No. 10/458,099, filed on Jun. 10, 2003, now Pat. No. 7,066,415.

(51) Int. Cl. B02C 25/00; B02C 18/06; E03C 1/266; B02C 23/36

(52) U.S. Cl. 241/36; 241/33; 241/46.013

(57) ABSTRACT

A touch pad control information system for a food waste disposer is disclosed. The touch pad is mountable to a wall or countertop near the food waste disposer. The touch pad preferably includes switches which allow the user to select from a plurality of disposer functions, and light emitting diodes (LEDs) or other graphic display to indicate one of a plurality of statuses for the disposer. The touch pad is coupled to the disposer by a wire bus or by wireless means.

### CROSS-REFERENCE TO RELATED APPLICATIONS

This application is a continuation of U.S. patent application Ser. No. 11/306,143 filed on Dec. 16, 2005. U.S. Ser. No. 11/306,143 is a continuation-in-part of U.S. patent application Ser. No. 10/458,099 filed Jun. 10, 2003 (now U.S. Pat. No. 7,066,415). The disclosures of the above applications are incorporated herein by reference.

### FIELD OF THE INVENTION

The present invention relates generally to a food waste disposer and more particularly to a touch pad control information system for a food waste disposer.

### BACKGROUND OF THE INVENTION

Food waste disposers are used to comminute food scraps into particles small enough to safely pass through household drain plumbing. A conventional disposer includes a food conveying section, a motor section, and a grinding mechanism disposed between the food conveying section and the motor section. The food conveying section includes a housing that forms an inlet connected to a sink flange for receiving food waste and water. The food conveying section conveys the food waste to the grinding mechanism, and the motor section includes a motor imparting rotational movement to a motor shaft to operate the grinding mechanism.

Common food waste disposers are typically single speed devices usually operated by a switch that which is often mounted to a wall in near vicinity to the disposer (e.g., beside the sink to which the disposer is affixed). This may not be most advantageous, because a single grinding speed is not always optimal for grinding foods of different hardnesses or constituencies, and otherwise limits the functionality of the disposer.

For example, U.S. Pat. No. 6,481,652, which is incorporated herein by reference in its entirety, discloses a food waste disposer which can operate at various speeds to either optimize grinding or perform other beneficial functions. For, example, the '652 patent recognizes that it can be beneficial to grind softer or stringy foods at higher speeds, while grinding harder foods at slower speeds. Accordingly, a grinding algorithm (or mode) is disclosed in the '652 patent in which the disposer grinds at a high speed for a set time, followed by a medium speed for a set time, followed by a low speed. This optimized grinding algorithm is beneficial in that it allows food of all hardnesses to be optimally ground during at least one portion of the grind cycle.

Other useful algorithms are disclosed in the '652 patent. For example, a soft start mode is disclosed, during which the speed of the disposer is gradually increased after it is turned on by the user so that the disposer does not become overwhelmed and clogged by an initial slug of food waste. An idle mode detects whether food waste is present in the disposer, and drops the disposer's speed during periods when the food waste disposer is empty (such as when the user is walking back and forth between the dinner table) to decrease the noise of the disposer. A rinse mode increases the speed of the disposer near the end of a grinding cycle to more effectively splash water within the grinding chamber to wash it clean, thereby reducing foul odors. An anti-jamming mode allows for the detection of objects that have might have jammed the disposer, such as eating implements (e.g., spoons, forms, or knives) or bone fragments, and automatically takes corrective action, for example, by reversing the direction of rotation of the motor that performs the grinding in an attempt to dislodge the jam. (Further details concerning some of these modes can be found in U.S. patent application Ser. No. 10/262,776, filed Oct. 2, 2002 (now U.S. Pat. No. 6,854,673), which is incorporated herein by reference). All or some of these algorithms disclosed in the '652 patent can be concatenated together (e.g., soft start, then optimizing grinding, then rinse), with perhaps the idle and anti-jamming modes running in the background should idleness or jamming become an issue during a grinding operation.

However, these disclosed algorithms are not controllable, or modifiable, by the user, and instead are automatically implemented by a motor controller when the disposer is turned on. Such a hands-off approach may not always be desirable. For example, if only hard foods such as bone fragments are to be ground, the high and medium speed portions of the optimized grinding algorithm may not be useful, and might therefore preferably be dispensed with. Likewise, for stringy foods, like celery, it might only be preferable to operate the disposer at a high speed. If the disposer smells bad, the user may simply wish to run the rinse mode without having the disposer perform the optimized grinding mode at all. In short, the user has little control over how the disposer is to be operated, and instead must be content that the disposer will perhaps perform all of these potential algorithms whether they are needed or not.

In addition to lack of user control, disposers such as those disclosed in the '652 patent provide the user with no indication of what the disposer is doing at any given time. This lack of feedback impedes the benefits that improved functionality provides. For example, the user may wish to know when the disposer is running the idle mode algorithm, which might indicate to the user that the disposer is empty and can now be turned off, or that the rinse mode should be activated. In another example, it is useful for the user to know if the disposer is running the anti-jamming algorithm. Although this algorithm preferably performs its own corrective action measures, the user may still need to intervene, for example, by removing an eating implement from the grinding chamber so that the disposer will not become jammed again. Stated more generally, it is useful for the user to have some feedback concerning what is occurring with the disposer to enable the user to take appropriate actions.

In short, while food waste disposers such as those disclosed in the '652 patent have improved functionality over more commonplace single speed disposers, they provide no mechanism to allow users to take full control of that functionality, and further provide no indication concerning the functions being performed or the status of the disposer, which hampers the usefulness of this increased functionality.

Conventional food waste disposers produce noise during operation. This is due, in part, by the operation of the motor as well as by the food impacting against the disposer body and grind components. Thus, the fact that an older disposer is “on” or running is obvious to a person in the vicinity of the disposer. However, several means have been developed and employed to reduce disposer noise. For example, sound insulating materials have been placed around the exterior housing of the disposer to reduce noise. A baffle may be provided between the disposer inlet and the drain opening, which keeps food waste from getting “kicked back” up through the drain opening when the disposer is operating and additionally prevents some of the noise from the disposer from traveling up through the sink to be heard by users. Still further, anti-vibration mounting systems have been used to reduce noise generated by the disposer motor vibrations and vibrations resulting from food impacting the inside of the disposer.

Improved operating modes for disposers have further reduced noise. For example, the '652 patent discloses an algorithm in which an idle mode detects whether food waste is present in the disposer, and drops the disposer's speed during period when the food waste is empty (such as when the user is walking back and forth between the dinner table and the disposer) to decrease the noise of the disposer.

As noted above, the noise generated by older disposers makes it easy to discern whether a disposer is operating. A newer disposer, however, can be so quiet when operating that it is difficult to tell whether it is on. Conventional disposers provide the user with no indication of the disposer's operation status.

### SUMMARY OF THE INVENTION

Disclosed herein is a touch pad control information system for a food waste disposer. The touch pad is mountable to a wall or countertop near the food waste disposer. The touch pad preferably includes switches which allow the user to select from a plurality of disposer functions, and light emitting diodes (LEDs) or other graphic display to indicate one of a plurality of statuses for the disposer. The touch pad is coupled to the disposer by a wire bus or by wireless means.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates a food waste disposer mounted under a sink and coupled to a touch pad by a bus;

FIG. 2 illustrates the touch pad in further detail;

FIG. 3 illustrates a circuit schematic for controlling and monitoring the operation of the food waste disposer using the touch pad;

FIGS. 4 and 5 illustrate embodiments of disposer systems having audio indicators;

FIG. 6 illustrates a food waste disposer system having a disposer mounted under a sink and coupled to an audio indicator;

FIGS. 7 and 8 are perspective views of an audio indicator housed in an enclosure; and

FIG. 9 is a schematic diagram of an audio indicator system.

### DETAILED DESCRIPTION OF THE PREFERRED EMBODIMENTS

The following description of the preferred embodiment(s) is merely exemplary in nature and is in no way intended to limit the invention, its application, or uses.

In the interest of clarity, not all features of actual implementations of a touch pad control information system for a food waste disposer are described in the disclosure that follows. It should be appreciated that in the development of any such actual implementation, as in any such project, numerous engineering and design decisions must be made to achieve the developers' specific goals, e.g., compliance with mechanical and business related constraints, which will vary from one implementation to another. While attention must necessarily be paid to proper engineering and design practices for the environment in question, it should be appreciated that the development of a touch pad control information system for a food waste disposer would nevertheless be a routine undertaking for those of skill in the art given the details provided by this disclosure.

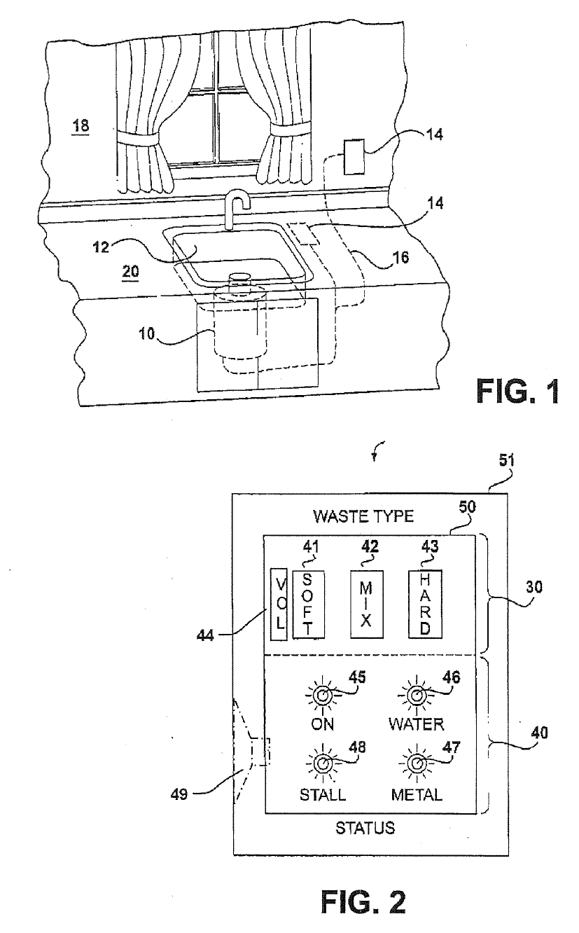

FIG. 1 shows a disposer 10 mounted under a sink 12, and in electrical communication with a touch pad control information system 14 (hereinafter touch pad 14). The touch pad 14 preferably communicates with the disposer 10 through the use of a conduit or bus 16, which contains the wires that span between the disposer and the touch pad in accordance with a circuit schematic to be explained later. However, and as explained later, the touch pad 14 and disposer can also communicate by a wireless link. The touch pad is illustrated as mounted to a wall 18, but could also be attached to an adjacent countertop 20 as shown in dotted lines. As one skilled in the art will recognize, when routing the bus 16, normal wiring considerations should be made to bypass the cabinetry and/or the wall.

FIG. 2 shows the touch pad 14 in further detail in one embodiment. The touch pad 14 includes a touch-sensitive switch area 30 and a status indicator area 40. The switch area 30 includes various switches for controlling the operation of the disposer 10. For example, in this embodiment, switch area 30 includes three switches 41, 42, and 43 for operating the disposer at respectively lower speeds. Because the user may not particularly care what speed is chosen, but is more concerned with adequately grinding food waste of a particular constituency, these switches 41-43 are conveniently labeled as “soft,” “hard,” and “mix.” Of course, these switches could be alternatively labeled with motor speed (e.g., fast or slow, or with the actual motor rpm speed), but such technically-accurate information may not be as helpful to a lay user of the disposer 10.

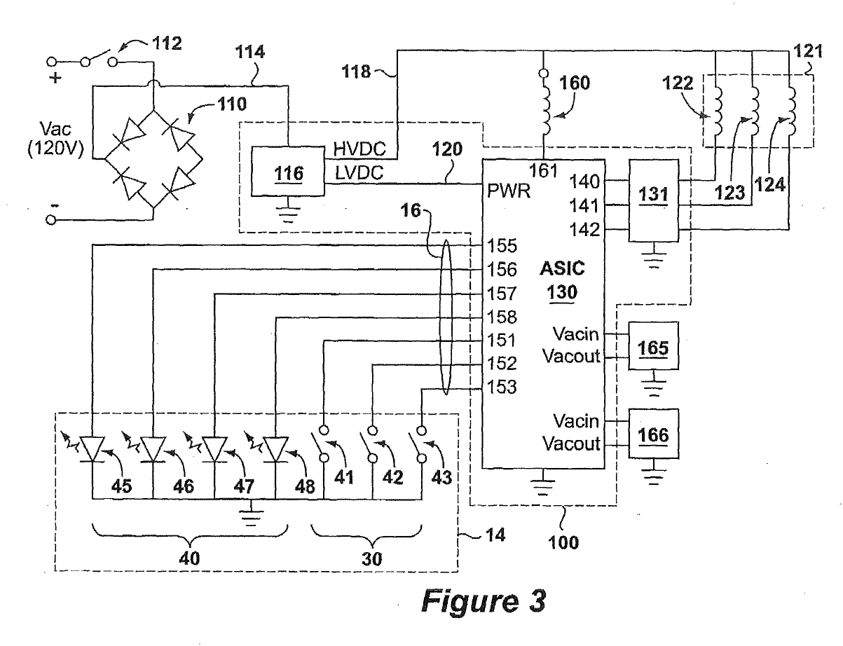

The status indicator area 40 provides the user information concerning the status of the disposer 10. For example, and as shown, the status indicator area 40 includes light, specifically light emitting diodes (LEDs) 45-48, which indicate that the disposer has been turned on (LED 45), that water is running within the unit (LED 46), that the unit has stalled because of a jam (LED 48), and that metal (e.g., an eating implement) has been detected in the disposer (LED 47). A circuit controller 100 controls the operation of the LEDs 45-48, and receives input from the switches 41-43, as will be explained in conjunction with the circuit diagram of FIG. 3.

In a preferred embodiment, the touch pad 14 is comprised of two parts: an electrical box 50 and an electrical box cover 51. Both of these components are preferably of a standard size used in household electrical outlets, with the electrical box 50 measuring 1.75×0.2.75 inches and the electrical box cover 51 measuring 2.75×4.5 inches. Of course, other sizes for these components could be used.

The switches 41-43 could comprise many different types of actuating switches, including regular light switches, or spring action buttons, but are preferably touch sensitive bubble switches which are common in the appliance industry.

Likewise, other types of indicators (conventional filament lights, gauges, etc.) could be used in lieu of LEDs 45-48. Or, the status indicator area 40 could comprise a textual readout, for example, a liquid crystal display or dot matrix display which would spell out the status (“running,” “idle,” “jammed,” “high speed,” etc.). In this embodiment, the display could include several lines or areas to allow multiple statuses to be displayed, if necessary (e.g., “jammed” and “metal in unit”). Alternatively, other non-visual indicators could be used, such as audible alarms which broadcast different noises or tones through a speaker (not shown) in accordance with the indicator being activated. In a more complicated approach, the speaker could broadcast the status by playing a recorded voice, which would “speak” the relevant status.

In a preferred embodiment, the electrical box 50 contains a single uniform layer of a plastic laminate over both the switches 41-43 and the LEDs 45-48, as is common in the appliance industry. This construction allows the function for the switches and a description of the status indicators to be written onto the laminate layer, while also protecting the switches and indicators from damage and moisture. As the laminate layer is basically flat, it is easily cleaned by with a damp cloth.

FIG. 3 shows a circuit controller 100 useable with the touch pad 14 and disposer 10. The components for the circuit controller 100 are preferably integrated on a single circuit board to be mounted in the body of the disposer, although other components may be separately placed elsewhere in the body of the disposer as dictated by their functions and by convenience. Alternatively, the circuit controller 100, and possibly some of the other components in FIG. 3, could be mounted outside of the food waste disposer. For example, they could be mounted on the outside of the disposer and appropriately housed, or could be integrated within or proximate to the electrical box 50 of the touch pad 14.

AC voltage (e.g., 120 AC) is input to the circuit controller 100 via a DC voltage generation circuit 110 which, for example, can regulate the voltage on line 114 to a voltage high enough to run both the disposer's motor 121 and an ASIC or SoC (System on a Chip) 130, as will be explained in further detail later. If the disposer 10 is a “batch feed” disposer, whereby the disposer can be run only after food waste has been placed in the disposer and a cover is positioned in the drain opening, the DC voltage generation circuit 110 may be interruptible by a lock cover switch 112 which interfaces with the cover, although this switch is not generally used for “continuous feed” disposers common in the United States market. (An example of a batch feed disposer having a cover for activating such a switch is disclosed in U.S. patent application Ser. No. 10/389,142 (now abandoned) and Ser. No. 10/389,160 (now abandoned), both filed Mar. 14, 2003, which are incorporated herein by reference).

The regulated voltage on line 114 is fed to a dual voltage regulator 116, which regulates the voltage on line 118 to a voltage high enough to energize the windings 122-124 of the motor 121, and which regulates the voltage on line 120 to a voltage high enough to power the ASIC 130. Such dual voltage regulators are well known and are not further described. Although shown as forming a portion of the controller 100, one skilled in the art will recognize that the voltage regulator 116 could constitute a separate component. Motor 121 may be any suitable variable speed motor, and preferably constitutes either a switched reluctance (SWR) motor or a brushless permanent magnet (BLPM) motor. Depending on the type of motor to be used, more or less motor windings could be used, as one skilled in the art of motorized appliances will understand.

Application Specific Integrated Circuit (ASIC) 130 is specially designed to provide the basic functionality to controller 100, and therefore to the motor 121 and to touch pad 14. In a preferred embodiment, ASIC 130 constitutes a mixed signal chip capable of handling both digital and analog signals. The various functions performed by ASIC 130, and its inputs and outputs are described herein. Because the technology for designing an ASIC chip to perform these described functions is advanced and well known in the art, and well within the skill of those skilled in the mixed signal processing arts, further details concerning the construction of ASIC 130 are not described.

The ASIC chip 130 contains various inputs and outputs. Switches 41-43, controlling motor speed, are input to the ASIC 130 at inputs 151-153 along bus 16. LEDs 45-48 are likewise coupled to outputs 155-158 of ASIC 130 along bus 16. The ASIC chip 130 at outputs 140-142 controls the timing of activation of the windings 122-124 in conjunction with switching circuit 131, which could perform varying functions depending on the exact type of motor 121 used as one skilled in the art of motorized appliances will understand. The switching circuit 131 may be integrated with the ASIC 130 or can remain separate therefrom. In response to closure of the switches 41-43 by the user, the motor speed is accordingly adjusted, which closure of the switches informing the ASIC chip 130 to affect the timing and/or current at outputs 140-142 for faster or slower motor operation. If the ASIC 130 detects that the drive current has become too high at outputs 140-142, a signal is sent to output 157 to light LED 47 on touch pad 14, i.e., the “unit stalled” LED. (Further details concerning detecting a jam condition are disclosed in U.S. patent application Ser. No. 10/262,776, filed Oct. 2, 2002 (now U.S. Pat. No. 6,854,673), which is incorporated herein by reference).

Other indicator LEDs in status indicator area 40 of the touch pad 14 function similarly. For example, if the disposer 10 has been turned on by the user, i.e., by pressing any of switches 41-43, the motor 121 is started and a signal is sent to output 155 by ASIC 130 to enable illumination of LED 45 to inform the user of this fact.

Similarly, turning on the disposer 10, in some applications, may start the flow of water through a water input conduit (not shown) into the grinding chamber of the disposer 10 through a controllable valve, as is well known. Such a valve is controllable by a water solenoid 160, which is coupled to output 161 of the ASIC 130, and which is engaged at start up to close the solenoid and open the valve to run water into the grinding chamber. In addition, if the water input conduit contains a flow sensor 165, the flow of water can be verified by the ASIC 130, which causes illumination of LED 46 on output 156. Water flow can be measured in a variety of different ways, including the use of mechanical or electrical flow devices providing digital or analog outputs as is known in the art.

The “water on” indicator LED 46 can also be used in disposers which do not have solenoid-controlled water input conduits. For example, traditional disposers 10 generally require the user to run water into the disposer during operation. Various flow sensors 165 could be used to detect the presence of water flowing through the disposer, for example, by placing a flow sensor in faucet inlet line or the discharge outlet from the grinding chamber. Accordingly, should LED 46 not be lit, the user is reminded to turn the water on to allow food waste to be properly ground, which protects the disposer from overheating, clogging, and damage.

Because some jams may be caused by metal objects such as eating implements, a metal sensor 166 can be used to detect this event. Such a device measures the inductive coupling between the grinding plate (via the rotor) and the shedder ring affixed to grinding chamber wall, which is grounded. By assessing the phase shift between an AC input interrogation signal sent by the ASIC 130, and a detected AC output, it can be inferred that a metal device has intervened in the magnetic field between the grinding plate and the shredder ring. Accordingly, if a sufficiently high phase shift is detected by the ASIC 130, the ASIC 130 can cause illumination of LED 47 on output 157, which would inform the user that the metal object needs to be retrieved from the grinding chamber of the disposer. If the metal object has also caused a jam in the disposer, LED 48 may also be illuminated as explained above. The sensor may also employ technologies other than inductive coupling, known to those skilled in the art.

In short, touch pad 14 provides the user with greater flexibility in operating the disposer, and provides a feedback mechanism to inform the user of the status of the disposer. Of course, other modifications are possible, both as to the degree of user control and disposer feedback.

For example, if a temperature sensor is used to monitor motor temperature, an LED could be included on the status indicator area of touch pad 14 to inform the user if the unit has overheated.

Moreover, many disposers are designed with current overload switches, which are typically located on the end (bottom) plate of the disposer 10, and which the user may need to reset before operating the disposer. (See, e.g., U.S. patent application Ser. No. 10/196,599, filed Jul. 16, 2002 (now U.S. Pat. No. 6,610,942), which is incorporated herein by reference). Should the overload switch need to be tripped, an LED labeled “overload” could be informed to notify the user of this fact. This can be a great benefit to the user, who otherwise might not understand why his disposer is no longer functioning.

If the disposer includes a bottle for administering additives into the grinding chamber, a fluid level sensor could be included with these bottles and coupled to the ASIC 130, which could then illuminate an LED to inform the user when these bottles are low and need to be refilled or changed.

Additionally, many of the benefits of the various operational algorithms in the above-incorporated '652 patent can be implemented with greater user control. For example, a switch similar to switches 41-43 could be used to run the above-mentioned soft start algorithm (or this could be automatically performed by the ASIC 130 when the disposer is turned on). Or, if the sink smells bad, the user may simply want to run the above-mentioned rinse mode without placing food waste in the disposer, and a switch could be incorporated to run that algorithm at the user's discretion. In another example, a switch could be used to run the above-mentioned idle mode. By toggling the idle mode switch, the ASIC 130 would be informed to drop the speed of the motor when the motor's drive current drops to lower levels, which, as explained in the above referenced U.S. patent applications, would happen when food waste is not present in the disposer. In addition, all or some of these modes could be programmed into the ASIC 130 and performed automatically, perhaps subject to user override by pressing a given switch.

The switches in the touch-sensitive switch area 30 and the LEDs (or other indicators) in the status indicator area 40 do not need to be positioned in separate areas of the touch pad 14 and may even be integrated. For example, if an idle mode switch is used, the face of that switch can include an LED to inform the user that this mode has been engaged. Or a light operated by or incorporated into each of the motor speed switches can illuminate when a given switch is pressed to inform the user of his motor speed selection. Similarly, a rinse mode switch, were such a switch used, could also contain an indicator light incorporated within the switch to inform the user that this mode has been selected.

It should be understood that these various user options, and status indicators, are merely illustrative and could constitute other options or indicators not mentioned in this disclosure.

The printed circuit board for the control circuitry 100 (and other associated circuitry, if any) can be bolted to the end (bottom) plate of the disposer, or could be similarly affixed to the cylindrical sides of the disposer, or elsewhere. As is a common practice, the printed circuit board preferably connects via a linear connector to an internal bus cord, which in turn communicates with a connector mounted through the disposer. Accordingly, bus 16, which preferably constitutes a cable having suitable terminals, could be plugged into this connector to quickly and easily electrically couple the disposer 10 to the touch pad 14.

In an alternative arrangement, the disposer 10 and the touch pad can communicate by wireless means. For example, the ASIC 130 on the control circuitry can connect to a short range transmitter/antenna, similar to those used in home telephones or garage door openers, or other wireless communication protocols, such as Bluetooth. The electrical box 50 of touch pad 14 could contain a similar transmitter/antenna, which would allow wireless communication between the disposer 10 and the touch pad 14. Such an arrangement would be simpler to implement as the user would not have to electrically connect the disposer 10 and the touch pad 14, and would not have to accommodate routing of a bus 16 though his wall or cabinetry.

While it is preferred that the touch pad 14 include both a switch area 30 and a status indicator area 40, this in not strictly necessary. For some applications, only a switch area 30, allowing the user to select the function of the disposer may be necessary without the need for status information. In other applications, only the status indicator area 40 may be needed, if user control is not an issue. For example, if the disposer is not a multi-speed disposer, or otherwise does not have multiple user-engageable functions, then a mere display area to inform the user of the disposer's status can be used without switches.

When this disclosure refers to selecting from a plurality of disposer functions, it should be understood that a plurality of disposer functions does not constitute merely turning the disposer on and off. In other words, switches for merely turning the disposer on and off, e.g., an on and off switch in the switch area 30, do not allow for the selection of a plurality of disposer functions. Instead, a plurality of disposer function implies operating the disposer in a plurality of different ways.

In addition to, or in place of, the LED 45 that indicates whether the disposer is on, the control information system 14 includes an audio output device such as a speaker 49 to provide an audible indication that the disposer is running. For example, the “Audio On Indicator” provides a pre-programmed audio message, sound or music, via the speaker 49 when the disposer is turned on. The person using the disposer can choose his favorite song, sounds, or spoken message. A volume control 44 allows setting the volume of the audio indicator at the desired level.

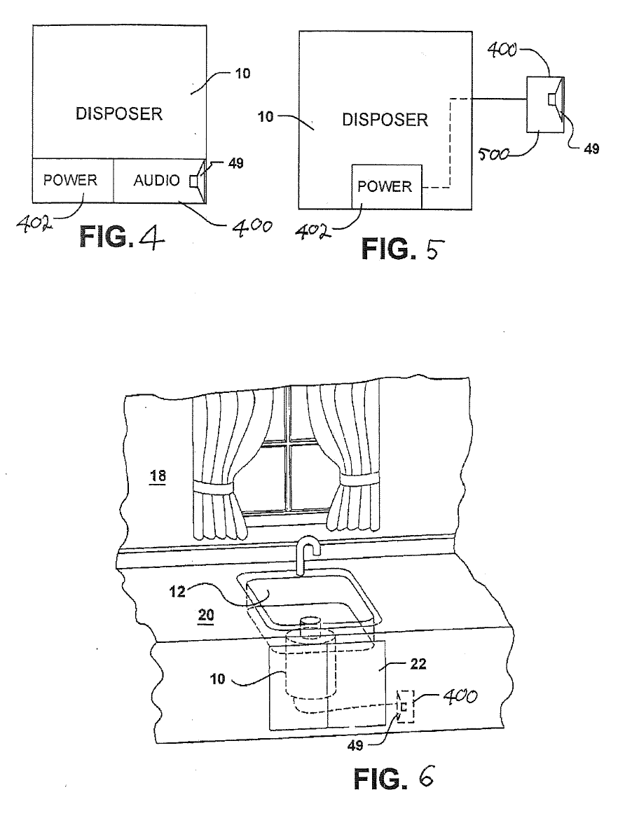

In some disposer installations, it is difficult or impractical to install the entire control information system 14. However, an indicator to notify a user that the disposer has been actuated may still be required. FIG. 4 is a block diagram conceptually illustrating an alternative embodiment of an audio indicator 400. In the illustrated embodiment, the indicator 400 is situated within the housing of the disposer 10 and is wired into the disposer's power supply 402. Alternatively, the indicator 400 may be powered by a separate power supply. The indicator 400 includes power circuitry, if necessary, to adjust the received power as necessary to power an audio circuit and speaker 49. The disposer 10 includes openings in its housing for the speaker 49 output and for access to the indicator 400 for programming the device.

In FIG. 5, another embodiment is shown in which the indicator 400 is situated in a separate enclosure 500. The speaker 49 and audio circuitry are situated inside the enclosure 500. The indicator 400 may receive power from the disposer 10 as shown in FIG. 5, or a separate power supply could be used. The enclosure 500 can be installed in a convenient location, such as next to the disposer power switch in the wall or counter adjacent to the sink. Alternatively, to prevent the labor of cutting openings in the wall or counter and associated finish work, the enclosure 500 can be mounted inside the cabinet containing the disposer as shown in FIG. 6. Locating the enclosure 500 near a cabinet door 22 allows people to hear the sounds emitting from the speaker 49.

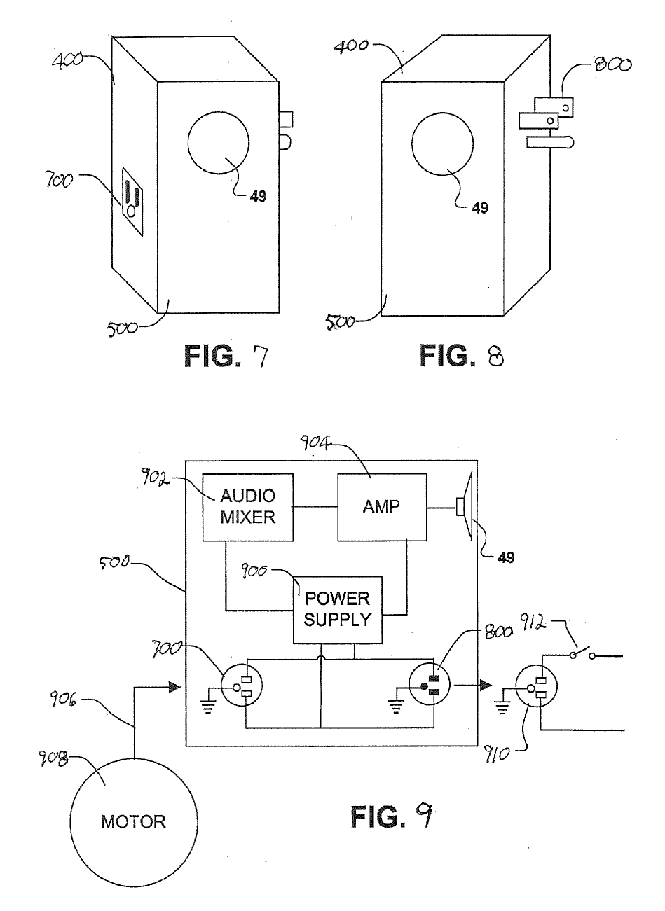

FIGS. 7 and 8 show perspective views of an audio indicator 400 that can be easily added to an installed disposer system. The audio indicator includes an enclosure 500 that has a standard AC outlet 700 on one side, and a standard electrical plug 800 on the opposite side. As shown in FIG. 9, the enclosure 500 further contains a power supply 900 connected to the outlet 700 and plug 800. An audio mixer 902 and amplifier 904 provide an output to the speaker 49 and receive power from the power supply 900.

Rather than plugging the power cord 906 for the disposer's motor 908 directly into a switched outlet as in standard installations, the power cord 906 plugs into the outlet 700 of the audio indicator 400, and the plug 800 is received by a switched outlet 910 that is connected to standard household power via a wall switch 912. When the switch is closed to activate the disposer motor 908, the indicator 400 is also activated to produce the audio indicator through the speaker 49.

The indicator 400 can be programmed to play a variety of sounds to provide an indication that the disposer is on, such as a pre-programmed voice message, sound or music. As noted herein, disposers without technology to reduce noise do not need a separate indicator because it is immediately evident that the disposer is operating from the noise it generates. Further, the generated noise is not particularly pleasant to most disposer users. The audio indicator 400 disclosed herein can make food preparation tasks and clean-up more pleasant for the consumer or cook by allowing them to hear pleasant sounds or their favorite music when the disposer is operating.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A food waste disposer system, comprising:
a food waste disposer having a motor and a controller coupled to the motor; and
a control panel in wireless communication with the controller having a plurality of switches that can be depressed by a user to choose from a plurality of functions that the food waste disposer can perform, upon the user depressing a switch, the control panel wirelessly communicating to the controller which switch the user depressed, the controller controlling the food waste disposer in response to the wireless communication from the control panel to perform the function associated with the switch depressed by the user.

2. The system of claim 1 wherein the plurality of functions include a plurality of motor speeds, the controller controlling the speed of the motor to a speed selected by which switch the user depresses.

3. The system of claim 2 wherein the plurality of functions include a soft start mode, a rinse mode, an optimized grinding mode, and an idle mode.

4. The system of claim 1 wherein the control panel includes a touch sensitive area that includes the plurality of switches.

5. The system of claim 4 wherein the control panel includes a status indicator area including a plurality of status indicators for indicating status of a plurality of status conditions of the food waste disposer.

6. The system of claim 5 wherein the status conditions include a plurality of conditions detected by the controller that communicates their status wirelessly to the control panel, the control panel controlling one of the status indicators for each such status condition in response to the wireless communication from the controller, the status indicators including a status indicator for each status condition detected by the controller.

7. The system of claim 6 wherein the conditions detected by the controller include a jam condition, presence of water in the food waste disposer, presence of metal in the food waste disposer, and the presence of power to the food waste disposer.

8. The system of claim 5 wherein the status indicators include an audible indicator.

9. The system of claim 5 wherein the status indicators include a textual display.

10. The system of claim 5 wherein the status indicators include a light.

11. The system of claim 5 wherein the status conditions include the function chosen by the user.

12. The system of claim 1 wherein the control panel includes a plurality of status indicators for indicating status of a plurality of status conditions of the food waste disposer.

13. The system of claim 12 wherein the status indicators include an audible indicator.

14. The system of claim 12 wherein the status indicators include a textual display.

15. The system of claim 12 wherein the status indicators include a light.

16. The system of claim 12 wherein the status conditions include the function chosen by the user.

17. The system of claim 12 wherein the status conditions include a plurality of conditions detected by the controller that communicates their status wirelessly to the control panel, the control panel controlling one of the status indicators for each status condition in response the wireless communication from the controller, the status indicators including a status indicator for each condition detected by the controller.

18. The system of claim 17 wherein the conditions detected by the controller include a jam condition, presence of water in the food waste disposer, presence of metal in the food waste disposer, and the presence of power to the food waste disposer.

19. The system of claim 1 wherein the control panel is mounted to a countertop or in a wall located proximate to the food waste disposer.

20. The system of claim 19 wherein the control panel includes an electrical box and an electrical box cover, the electrical box measuring approximately 1.75 inches×2.75 inches and the electrical box cover measuring 2.75×4.5 inches.

21. The system of claim 1, including a metal sensor coupled to the controller that detects the presence of a metal object in a grind chamber of the food waste disposer, the control panel including a status indicator for indicating the presence of a metal object in the grind chamber, the controller communicating wirelessly with the control panel to activate the status indicator that indicates the presence of the metal object in the grind chamber upon the metal sensor detecting the presence of the metal object in the food waste disposer.

22. The system of claim 21 wherein the food waste disposer includes a stationary shredder ring and a rotatable grinding plate rotatable by the motor, the metal detector responsive to inductive coupling between the grinding plate and the shredder ring and detecting whether a metal object is in the food waste disposer based on the inductive coupling.

23. The system of claim 1, further including a water solenoid activated by the controller when the food waste disposer is started.

24. The system of claim 1, further including a lock cover switch that couples an AC input of the food waste disposer to a source of AC voltage in response to a cover being situated in a drain opening of the food waste disposer.
